(19) United States
(12) Patent Application Publication
(10) Pub. No.: US 2004/0108446 A1
(43) Pub. Date: Jun. 10, 2004

(54) Arrangement and method for detecting an optical signal on the long side of an optic fibre

(76) Inventor: Eric Hildebrandt, Frankfurt/Main (DE)

Correspondence Address: KENYON & KENYON, ONE BROADWAY, NEW YORK, NY, 10004, US

(21) Appl. No.: 10/468,763

(22) PCT Filed: Jan. 25, 2002
(86) PCT No.: PCT/EP02/00779

(30) Foreign Application Priority Data
Feb. 21, 2001 (DE) 101 08 303.3

(51) Int. Cl. G01J 1/04; G01J 5/08

(52) U.S. Cl. 250/227.14

(57) ABSTRACT

The invention relates to an arrangement for detecting an optical signal which enables the light emitted from a curved optical fibre (40) on the long side thereof to be detected. Said arrangement comprises a device (10) for curving the optical fibre (40), a first retaining device (20, 30) for maintaining the optic fibre (40) in its curved state, and a second retaining device (60) for maintaining at least one photodetector (70). The curving device (10) and the second retaining device (60) are displaceable in relation to each other, whereby the photodetector (70) is placed directly on to a predetermined section of the curved optical fibre (40) in an operating state. As a result, the optical path between the fibre section, where the light is emitted from, and the photodetector (70) is minimal.

The invention is directed to a system, as well as to a method for detecting an optical signal that exits at the longitudinal side of an optical fiber.

In optical communications technology, the optical fiber plays a special role as a transmission medium. Due to the rapid growth in the fields of application for optical fibers, it is becoming ever more important to provide techniques for monitoring optical fibers.

The object underlying the present invention is, therefore, to provide a system, as well as a method for detecting an optical signal at the longitudinal side of an optical fiber.

The fundamental idea of the present invention is to be able to efficiently make use of the known effect whereby, when working with a bent optical fiber, a small fraction of the light exits from the fiber. To this end, a system is devised which will enable a high proportion of the light emerging from the fiber to be captured and converted into an electrical signal. This system is not only suited for monitoring an optical fiber, but is also suited for use, for example, as a reception unit in a set-top box for receiving a digital television program transmitted over the optical fibers.

The present invention achieves this technical objective, first of all, by employing the features of claim 1.

According to this claim, a system for detecting an optical signal at the longitudinal side of an optical fiber is provided. The system includes a device for bending the optical fiber. A first holding device ensures that the optical fiber may be held in the bent state. A second holding device supports at least one photodetector.

The bending device and the second holding device are movable in relation to one another in such a way that, in the operating state, the photodetector engages directly on a predeterminable section of the bent optical fiber.

A further refinement relates to a control mechanism which is used to position the photodetector against the section of the bent optical fiber where the largest fraction of light emerges.

As a photodetector, a semiconductor photodiode is preferably used, which has a light-sensitive region at one of its surfaces. To enable as much light as possible to fall on the light-sensitive region, the light-sensitive region of the photodetector is at least partially positioned, in the operating state, directly on the predeterminable section of the bent optical fiber. The light-sensitive region advantageously abuts tangentially against the optical fiber section.

To protect the light-sensitive region of the photodetector from damage, an optically transparent protective coating may be applied to the detector surface, at least partially over the light-sensitive region.

In certain photodiodes, a thin bonding wire, mostly in the form of a gold wire, leads from the light-sensitive region to a connection pin which is connected to external connections of the photodiode. In this case, when applying the optically transparent protective coating to the detector surface, it is useful to also include the bonding wire itself, to prevent it from breaking off. A UV-hardenable optical adhesive agent may be used, for example, as an optically transparent protective coating.

It is pointed out here that, because of the small dimensions of the photodiode, the protective coating tends to take on the shape of a droplet formation. By applying an optically transparent coating to the detector surface, the detector is brought, in its operating state, into direct contact with the predeterminable section of the bent glass fiber.

Alternatively or in addition to the optically transparent protective coating, an optical lens, such as a GRIN lens, may be placed on the detector surface, to enable light emerging from the fiber section to be additionally focused at the light-sensitive region of the photodetector.

Alternatively or in addition to the optically transparent coating and/or the optical lens, an additional optical coating, or also a system composed of a plurality of layers may be applied. These function as filters and allow light of a predefined wavelength or of a predefined wavelength range to pass through. Methods for applying and producing such optical coatings are generally known and do not constitute the subject matter of this invention.

Each of these coatings may have larger dimensions, preferably in the longitudinal direction of the optical fiber, than the light-sensitive region of the photodetector. In addition, at least the external optical coating may preferably have a curved groove into which the bent section of the optical fiber is insertable.

The optical coatings may additionally be at least partially reflecting, in order to enhance the intensity of the light impinging on the light-sensitive region of the photodetector.

In the simplest case, the bending device may be an interchangeable rod having a round cross-section and a predefined diameter.

The rod is provided with a protective coating to prevent damage to the optical fiber. In addition, a guide groove for guiding the optical fiber to be bent may be recessed in the rod or in its protective coating. This makes it possible to prevent the optical fiber to be bent from slipping in the longitudinal direction of the rod.

The degree of bending of the optical fiber depends, on the one hand, on the radius of the bending rod, and, on the other hand, on the position of the first holding device relative to the bending rod. In the Specification, the radius of the bending rod is referred to as bending radius, and the angle enclosed by the bent optical fiber as looping angle. For example, the bending radius is two millimeters and the looping angle about 130°. A looping angle of 180° would correspond to a straight optical fiber.

The first holding device may have two spaced-apart holding elements, which are movable in relation to one another and to the bending device.

Each holding element preferably has a wedge-grip pair for holding a corresponding optical fiber section. The wedge grips of each wedge-grip pair are positioned so as to be movable towards each other and away from each other in the longitudinal axis direction of the bending rod or in the plane formed by the bent optical fiber.

To prevent each of the optical-fiber sections from slipping sideways, the wedge grips of each wedge-grip pair have a groove for accommodating the particular optical-fiber section. The wedge grips may be provided with a padding, for example of rubber, to prevent pressure points from forming on the optical fiber and damaging the same.

To be able to detect optical signals in both directions of the optical fiber using the system according to the present invention, two photodetectors are provided. They are positioned at the corresponding, bent sections of the optical fiber and detect the light exiting from the fiber section in question.

The two photodetectors are rigidly connected via the second holding device. Alternatively, the second holding device may be designed to enable the photodetectors to be movable independently of one another.

The photodetector is connected to a high-frequency amplifier, which amplifies the electrical signals generated by the photodetector from the optical signals, for appropriate further processing.

To achieve a compact and small as possible design, photodetectors and high-frequency amplifiers are able to be manufactured as integrated. This makes it possible to clearly minimize the size of the lead wire between the photodetector and the high-frequency amplifier and, thus, the line attenuation.

To be able to optimally align the optical fiber and the photodetector to one another, the bending device and/or the second holding device have a manually or automatically operated drive unit assigned thereto, for positioning the photodetector on a predeterminable section of the bent optical fiber.

To prevent the optical fiber itself or the photodetector from becoming damaged when the photodetector is pressed against the optical fiber, a contact-pressure regulator is assigned to the drive unit. It ensures that an adjustable pressure is applied to the photodetector at the predetermined section of the optical fiber.

The entire system may be implemented on a mounting plate as a hand-held instrument which is connectible to an optical fiber.

It is also conceivable to design the system as an automated bench unit or as a mobile device.

A PIN or APD diode may be used as a photodiode, for example.

The technical objective mentioned above is likewise achieved by the method steps of claim 16.

According to this claim, a method is claimed where an optical fiber is first bent at a predefined location at an adjustable angle. The optical fiber is then held in the bent condition. To detect the light emerging from the bent section, a photodetector is initially placed directly against a predeterminable section of the bent optical fiber.

The fiber section against which the photodetector is to be placed, corresponds functionally to the section from which the most light emerges.

One advantageous embodiment constitutes the subject matter of the dependent claim.

The present invention is elucidated in the following on the basis of an exemplary embodiment, in conjunction with the enclosed drawing, whose figures show:

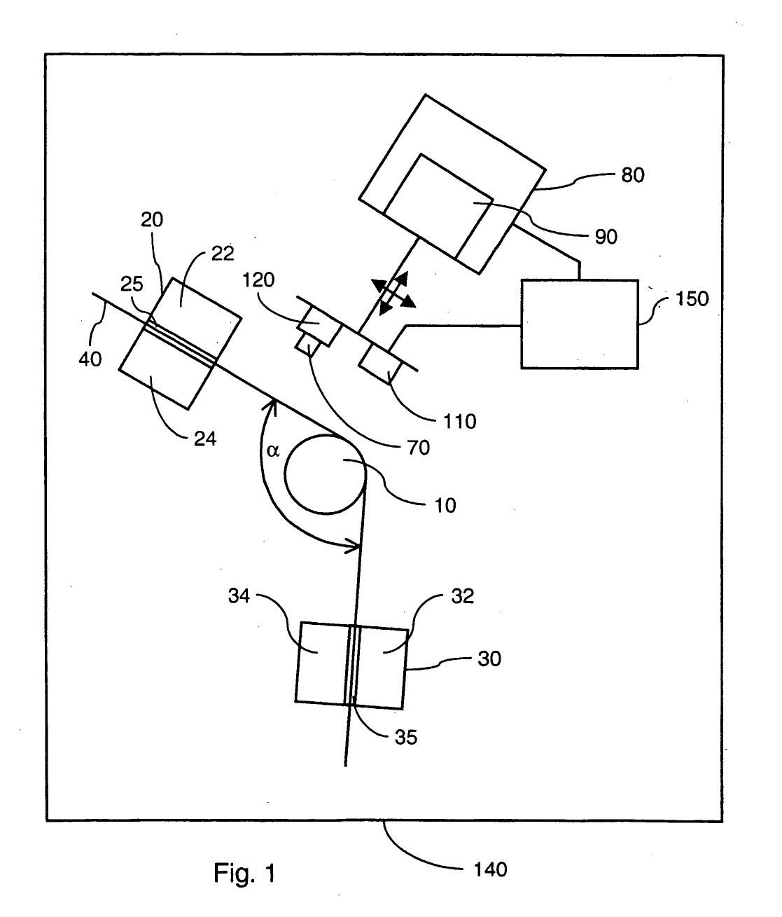

FIG. 1 in a simplified presentation, a plan view of the system according to the present invention,

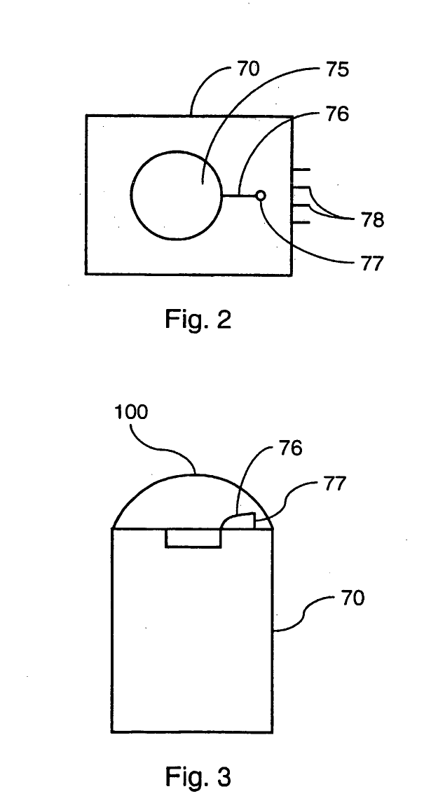

FIG. 2 the plan view of a PIN diode used in the system according to FIG. 1, and

FIG. 3 a side view of the PIN diode shown in FIG. 2.

FIG. 1 schematically depicts a system which is mounted on a mounting plate 140 and includes a bending rod 10 having a circular cross-section. For the sake of a better representation, neither the system itself nor the individual components are shown true-to-scale or in correct proportions to one another. In accordance with the exemplary embodiment, bending rod 10 has two holding devices 20 and 30 assigned thereto, each having two wedge grips 22, 24 and 32, 34, respectively. The wedge grips of each holding device move toward and away from each other in the plane formed by an optical fiber 40 bent by bending rod 10. Alternatively, each holding device 20 and 30 may have two vertically superposed wedge-grip holders for accommodating a predefined section of optical fiber 40. The surface of each wedge-grip holder 22, 24, 32 and 34 facing optical fiber 40 may have a rubber coating to prevent any damage to optical fiber 40. To prevent optical fiber 40 being held, from slipping out sideways, guide grooves 25 and 35, respectively, are introduced into the wedge-grip holder. Holding devices 20 and 30 cooperate with bending rod 10 in order to bend the optical fiber at a certain angle and to keep it in the bent condition. To this end, holding devices 20 and 30 are able to be moved in relation to one another and to bending rod 10. On the one hand, holding devices 20 and 30 may be moved along the longitudinal axis of optical fiber 40 in order to hold the fiber section situated therebetween under a predetermined tensile stress. In addition, holding devices 20 and 30 may be moved toward or away from imaginary line 50 running through bending rod 10, in order to change looping angle α formed by bent optical fiber 40.

Bending rod 10 may have a protective coating which prevents optical fiber 40 resting against it from being damaged. To prevent optical fiber 40 from slipping vertically on bending rod 10, a guide groove is recessed in bending rod 10.

At a distance from bending rod 10, a holding device 60 is mounted, to which a photodetector, for example a PIN diode 70, together with a high-frequency amplifier 110, is secured in the present example. Photodetector 70 and high-frequency amplifier 110 communicate electrically with one another. To minimize the size of the lead wire between photodetector 70 and high-frequency amplifier 110, it is conceivable to manufacture photodetector 70 and high-frequency amplifier 110 as an integrated unit. Photodetector 70 rests on a small platform 120 and, thus, projects above high-frequency amplifier 110. In this manner, as explained further below, photodetector 7b, may be placed directly against optical fiber 40, without the constructional size of the high-frequency amplifier causing any difficulty. Holding device 60 is connected to a drive unit 80, which is able to drive photodetector 70 up to a predefined section of bent optical fiber 40. PIN diode 70 is secured to holding device 70 in such a way that light-sensitive region 75 is assigned to optical fiber 40. Drive unit 80 may be a manually or, for example, electromechanically actuated drive.

FIG. 2 shows a plan view of PIN diode 70, which includes a light-sensitive region 75 on the surface facing optical fiber 40. A bonding wire extends from light-sensitive region 75 to an electrical connecting pin 77, which is connected to external contact elements 78 of PIN photodiode 70.

FIG. 3 shows a side view of PIN diode 70. On the surface facing optical fiber 40, an optically transparent protective coating 100 is applied in the form of a droplet. In the present example, it covers the entire surface and, thus, also light-sensitive region 75 and bonding wire 77. Protective coating 100 prevents bonding wire 76 from being damaged or broken off when detector surface is pressed onto bent optical fiber 40. A groove 105, into which a predefined, bent section of optical fiber 40 may be pressed, may be introduced into protective coating 100. It is also conceivable, alternatively or additionally, for another optical coating, which acts as a lens, to be applied to protective coating 100. The lens may have a curved groove, into which a corresponding section of optical fiber 40 is inserted when photodetector 70 is pressed against optical fiber 40. The lens may be at least partially reflecting, in order to direct the light beams emerging from the bent fiber section at light-sensitive region 75 of photodetector 70. Without a lens, the light beams would be lost.

Assigned to drive unit 80 is a contact-pressure regulator 90 which prevents the photodetector from being pressed under too great a pressure against optical fiber 40.

In operation, PIN diode 70 is driven by drive unit 80 up to a predefined section of bent optical fiber 40 and tangentially pressed against the section having an adjustable pressure, so that light-sensitive region 75 abuts directly on optical fiber 40. If, as shown in FIG. 3, the surface of photodetector 70 is covered with a protective coating 100, then protective coating 100 is pressed directly against the fiber section. This ensures a minimal length of path between the location where the light exits from bent optical fiber 40, and the light-sensitive region of photodetector 70.

PIN diode 70 is preferably placed against the fiber section out of which the highest light intensity emerges due to the bending of the fiber. It is also conceivable to provide a control mechanism (150), which controls drive unit 80 as a function of the optical power detected by photodetector 70 in such a way that photodetector 70 is automatically placed against the optical fiber section where the greatest optical power emerges.

Instead of placing the optically transparent region of photodiode 70 directly against optical fiber 40, it is conceivable to place the rear substrate side of a photodetector against the optical fiber. Here, it is necessary to use a semiconductor photodetector which has a substrate which is much thinner than that of a conventional photodiode and whose rear side is polished. In addition, the absorption in the semiconductor material must be reduced in comparison to that of conventional photodetectors. Only then is it ensured that the light emerging from bent optical fiber 40 is able to be detected at all.

As already mentioned, it is also conceivable to place two spatially separate photodetectors against two predefined sections of bent optical fiber 40, to be able to detect optical signals which propagate in both directions over optical fiber 40. These sections are situated between the point of contact of optical fiber 40 with bending rod 10 and holding device 20 or 30.

What is claimed is:

1. A system for detecting an optical signal at the longitudinal side of an optical fiber (40), comprising a device (10) for bending the optical fiber (40), a first holding device (20, 30) for holding the optical fiber (40) in the bent state, a second holding device (60) for holding at least one photodetector (70), the bending device (10) and the second holding device (60) being movable in relation to one another in such a way that, in the operating state, the photodetector (70) engages directly on [fits directly on or makes direct contact with] a predeterminable section of the bent optical fiber (40).

2. The system as recited in claim 1, wherein in the operating state, the light-sensitive surface (75) of the photodetector (70) abuts substantially tangentially, at least partially against the predeterminable section of the bent optical fiber (40).

3. The system as recited in claim 1, wherein an optically transparent protective coating (100), an optical lens, in particular a GRIN lens and/or an optical filter, are applied to the light-sensitive surface (75) of the photodetector.

4. The system as recited in claim 3, wherein the optically transparent protective coating (100), the optical lens, and or the optical filter are provided with a curved guide groove (105) for guiding a bent optical fiber section.

5. The system as recited in one of claims 1 through 4, wherein the bending device (10) is an interchangeable rod having a round cross-section and a predefined diameter.

6. The system as recited in claim 5, wherein a protective coating envelopes the rod (10).

7. The system as recited in claim 5 or 6, wherein a guide groove is provided in the rod (10) for guiding the optical fiber (40) to be bent.

8. The system as recited in one of claims 1 through 7, wherein the first holding device (20, 30) has two spaced-apart holding elements.

9. The system as recited in claim 8, wherein the holding elements (20, 30) are movable in relation to the bending device and or to one another.

10. The system as recited in claim 8 or 9, wherein each holding element (20, 30) has a wedge-grip pair (22, 24; 32, 34) for holding an optical fiber section.

11. The system as recited in one of claims 1 through 10, characterized by two photodetectors, which are movable in relation to one another.

12. The system as recited in one of claims 1 through 11, wherein the photodetector (70) is connected to a high-frequency amplifier (110), and the photodetector (70) and high-frequency amplifier (110) are able to be manufactured as integrated.

13. The system as recited in one of claims 1 through 12, wherein the photodetector (70) is a photodiode.

14. The system as recited in one of claims 1 through 13, characterized by a drive unit (80) assigned to the bending device (10) and/or to the second holding device (20 30) for positioning the photodetector (70) on a predeterminable section of the bent optical fiber (40).

15. The system as recited in claim 14, wherein a contact-pressure regulator (90) is assigned to the drive unit (80) for positioning the photodetector (70) on a predetermined section of the optical fiber (40) using an adjustable pressure.

16. The system as recited in one of claims 1 through 15, characterized by a control mechanism (150), which controls the drive unit (80) as a function of the optical power detected by the photodetector (70) in such a way that the photodetector (70) is able to be automatically placed against the optical fiber section where the greatest optical power emerges.

17. A method for detecting an optical signal at the longitudinal side of an optical fiber (40), comprising the following method steps:
bending the optical fiber (40) at a predefined location at an adjustable angle (a), holding the optical fiber in the bent state, and positioning at least one photodetector directly on a predeterminable section of the bent optical fiber in order to detect coupled-out light.

18. The method as recited in claim 17,
wherein the light-sensitive surface of the photodetector is positioned using an adjustable pressure, preferably tangentially on the predeterminable section of the bent optical fiber.
